(19) United States
(12) Patent Application Publication
(10) Pub. No.: US 2015/0067291 A1
(43) Pub. Date: Mar. 5, 2015

(54) CONTROLLER, MEMORY SYSTEM, AND METHOD

(71) Applicant: Kabushiki Kaisha Toshiba, Minato-ku (JP)

(72) Inventors: Yukimasa MIYAMOTO, Yokohama-shi (JP); Kohei OIKAWA, Kawasaki-shi (JP); Takaaki MATSUMOTO, Minato-ku (JP)

(73) Assignee: Kabushiki Kaisha Toshiba, Minato-ku (JP)

(21) Appl. No.: 14/208,282

(22) Filed: Mar. 13, 2014

Related U.S. Application Data
(60) Provisional application No. 61/871,923, filed on Aug. 30, 2013.

(51) Int. Cl. G06F 3/06

(52) U.S. Cl. CPC G06F 3/0659; G06F 3/0604; G06F 3/0671; G06F 2003/0697
USPC 711/167

(57) ABSTRACT

According to the embodiments, a controller includes an arbiter, a command fetch unit, and a processing unit. The arbiter executes a retrieval process. The retrieval process is a process of selecting a queue, to which a command is issued, out of plural queues by retrieval according to a round robin method. The command fetch unit fetches a command from the selected queue. The processing unit executes a process according to the fetched command to a memory chip. The arbiter manages a retrieval position. When a new command is issued to any one of the plural queues in an empty state in which there is no queue to which a command is issued, the arbiter has the retrieval position jump to the queue to which the new command is issued.

### CROSS-REFERENCE TO RELATED APPLICATIONS

This application is based upon and claims the benefit of priority from U.S. Provisional Patent Application No. 61/871923, filed on Aug. 30, 2013; the entire contents of which are incorporated herein by reference.

### FIELD

Embodiments described herein relate generally to a controller, a memory system, and a method.

### BACKGROUND

Conventionally, a memory system such as an HDD or SSD is used as an external storage device of a host. For the memory system described above, there is a technique of storing plural commands received from the host into a queue, and executing the plural commands stored in the queue out of order. There may be plural queues storing commands.

### BRIEF DESCRIPTION OF THE DRAWINGS

FIG. 1 is a diagram illustrating an example of a configuration of a memory system according to a first embodiment.

FIG. 2 is a view for describing an algorithm of the retrieval by an arbiter.

FIG. 3 is a view illustrating an example of a configuration of the arbiter.

FIG. 4 is a flowchart for describing an operation of the memory system during an issuance of a command according to the first embodiment.

FIG. 5 is a flowchart for describing an operation of a priority order control unit.

FIG. 6 is a flowchart for describing a retrieval process according to the first embodiment.

FIG. 7 is a view illustrating an example of a configuration of a queue management unit according to a second embodiment.

FIG. 8 is a flowchart for describing an operation of a memory system during an issuance of a command according to the second embodiment.

FIG. 9 is a flowchart for describing a retrieval process according to the second embodiment.

### DETAILED DESCRIPTION

In general, according to the embodiments, a controller includes an arbiter, a command fetch unit, and a processing unit. The arbiter executes a retrieval process. The retrieval process is a process of selecting a queue, to which a command is issued, out of plural queues by retrieval according to a round robin method. The command fetch unit fetches a command from the selected queue. The processing unit executes a process according to the fetched command to a memory chip. The arbiter manages a retrieval position, and when a new command is issued to any one of the plural queues in an empty state in which there is no queue to which a command is issued, the arbiter has the retrieval position jump to the queue to which the new command is issued.

Exemplary embodiments of a controller, a memory system, and a method will be explained below in detail with reference to the accompanying drawings. The present invention is not limited to the following embodiments.

### First Embodiment

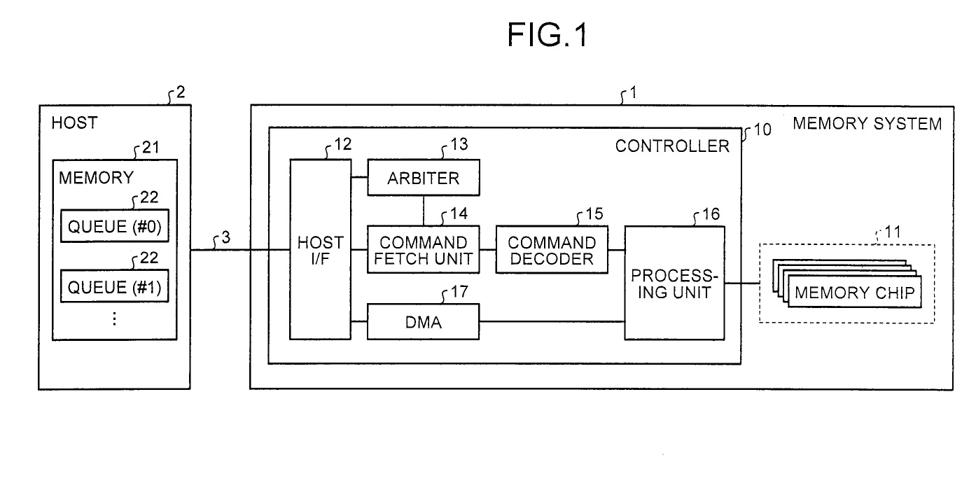

FIG. 1 is a diagram illustrating an example of a configuration of a memory system according to a first embodiment. A memory system 1 is connected to a host 2 via a communication path 3. The host 2 is a computer, for example. The computer includes a personal computer, a portable computer, and a mobile communication device. The memory system 1 functions as an external storage device of the host 2. Any interface standard can be applied to the communication path 3. For example, PCI Express is employed as the interface standard of the communication path 3. For example, NVM Express is employed as a command protocol transmitted through the communication path 3.

The host 2 has a memory 21 therein. The memory 21 has plural queues 22 in which a command from the host 2 to the memory system 1 is stored. Each of the plural queues 22 is identified by a queue number. Every time the host 2 issues a command to the memory system 1 in any one of the plural queues 22, the host 2 notifies the memory system 1 of the queue number indicating the queue 22 to which the command is issued and the number of the issued commands. Any information can be used as the information given from the host 2, so long as it can identify the queue 22 to which the command is issued and the issued command.

The memory system 1 has a controller 10 and a memory chip 11. The number of the memory chips 11 provided in the memory system 1 is arbitrary numbers of one or more. The memory chip 11 is non-volatile, for example. Any type of chip can be used as the memory chip 11. For example, NAND flash memory or NOR flash memory can be used as the memory chip 11. The controller 10 executes to control the memory chip 11 according to the command issued in the queue 22. For example, the controller 10 executes the data transfer from the memory chip 11 to the host 2 based upon a read command. The controller 10 also executes the data transfer from the host 2 to the memory chip 11 based upon a write command.

The controller 10 includes a host interface (I/F) 12, an arbiter 13, a command fetch unit 14, a command decoder 15, a processing unit 16, and a DMA 17.

The host I/F 12 executes to control the communication path 3. The host I/F 12 also accepts the queue number and a pointer notified from the host 2. The queue number and the pointer notified from the host 2 are inputted to the arbiter 13.

The arbiter 13 stores the pointer for each queue 22. The arbiter 13 retrieves the queue 22 having the command issued therein out of the plural queues 22. When finding the queue 22 having the command issued therein, the arbiter 13 inputs a fetch instruction for fetching the command from the queue 22 to the command fetch unit 14. Any fetch instruction can be used, so long as it can identify the command to be fetched. For example, the fetch instruction includes the queue number of the queue having the command to be fetched issued therein and the number of the commands to be fetched in the present embodiment.

The command fetch unit 14 fetches the command, which is instructed to be fetched, from the memory 21 via the host I/F 12 and the communication path 3. The command fetch unit 14 inputs the fetched command to the command decoder 15. An address of the memory 21 needed to fetch the command can be recognized by the structure in which the controller 10 has a table for holding the address for each command number.

The command transferred to the host I/F 12 is coded in the form conforming to the command protocol transmitted through the communication path 3. The command decoder 15 decodes the coded command into a format that can be interpreted by the processing unit 16. The command decoder 15 inputs the decoded command to the processing unit 16.

The processing unit 16 executes a process according to the command inputted from the command decoder 15. The process executed by the processing unit 16 includes a reading process of data from the memory chip 11 and a writing process of data to the memory chip 11. The command inputted from the command decoder 15 may include a logical address indicating a storage position of the data in the memory chip 11. The processing unit 16 may execute a mutual conversion between the logical address included in the command and a physical address in the memory chip 11. When the NAND flash memory is employed as the memory chip 11, the processing unit 16 may execute a wear leveling process or a garbage collection process. The processing unit 16 may execute an error correction coding process to the data read from or written on the memory chip 11. The processing unit 16 uses the DMA 17 for transferring the data read from the memory chip 11 to the host I/F 12 or for acquiring the data received from the host 2 to the host I/F 12.

The DMA 17 executes a direct data transfer between the host I/F 12 and the processing unit 16. The transfer data by the DMA 17 includes the data that is required to be written from the host 2 by the write command and the data that is required to be read from the host 2 by the read command. The DMA 17 executes the data transfer under the control of the processing unit 16.

Subsequently, a retrieval method by the arbiter 13 will be described.

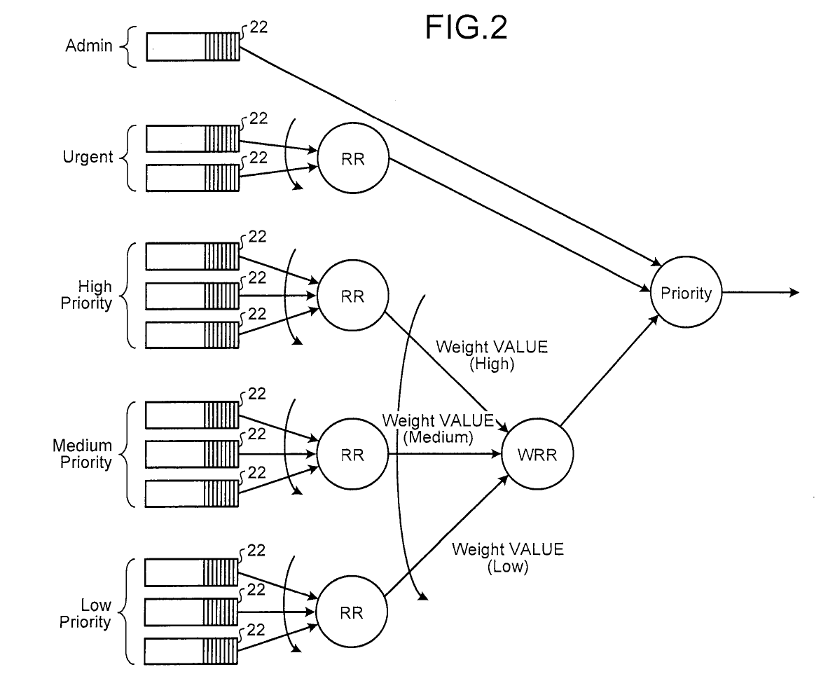

FIG. 2 is a view for describing an algorithm of the retrieval by the arbiter 13. A priority is set to the queue 22. In other words, the queues 22 are grouped for each priority. In the present embodiment, five levels that are “Admin”, “Urgent”, “High”, “Medium”, and “Low” are defined as the priority set to each queue 22 in the order of higher priority. There is one queue 22 (hereinafter referred to as Admin queue 22) to which the priority “Admin” is set. One or more queues 22 (hereinafter referred to as Urgent queue 22) to which the priority “Urgent” is set can be generated, and in FIG. 2, two Urgent queues 22 are present. One or more queues 22 (hereinafter referred to as High queue 22) to which the priority “High” is set, one or more queues 22 (hereinafter referred to as Medium queue 22) to which the priority “Medium” is set, and one or more queues 22 (hereinafter referred to as Low queue 22) to which the priority “Low” is set can be generated, and in FIG. 2, three High queues, three Medium queues, and three Low queues are present.

A Weight value according to each priority is defined for each of the priority “High”, the priority “Medium”, and the priority “Low”. The arbiter 13 sequentially selects any one of the priority “High”, the priority “Medium”, and the priority “Low”, and carries out the retrieval according to a round robin method with all queues 22 to which the priority currently selected being defined as a retrieval range. Defining all queues 22 to which the priority “X (X is any one of “High”, “Medium”, and “Low”)” is set as the retrieval range is described such that the priority “X” is defined as the retrieval range. The arbiter 13 carries out the retrieval with the selected priority being defined as the retrieval range. When the total number of the commands that are instructed to be fetched reaches the Weight value, the arbiter 13 changes the retrieval range to the next priority out of the priority “High”, the priority “Medium”, and the priority “Low”. Every time the arbiter 13 changes the retrieval range to the next priority for the priority “High”, the priority “Medium”, and the priority “Low”, the arbiter 13 carries out the retrieval for the Admin queue 22 and the Urgent queue 22 in this order. Specifically, the arbiter 13 carries out the retrieval in accordance with Weighted Round Robin with Urgent Priority Class Arbitration method. When there are plural Urgent queues 22, the arbiter 13 retrieves the Urgent queue 22, to which the command is issued, out of the plural Urgent queues 22 in accordance with the round robin method.

When a command is fetched from a queue 22, the command may be deleted or may not be deleted from the queue 22. When the command that is already fetched is not deleted, whether the command is already fetched or not may be managed for each command by a pointer indicating the position of the last command out of the commands that are already fetched, or a flag indicating whether the command is already fetched or not.

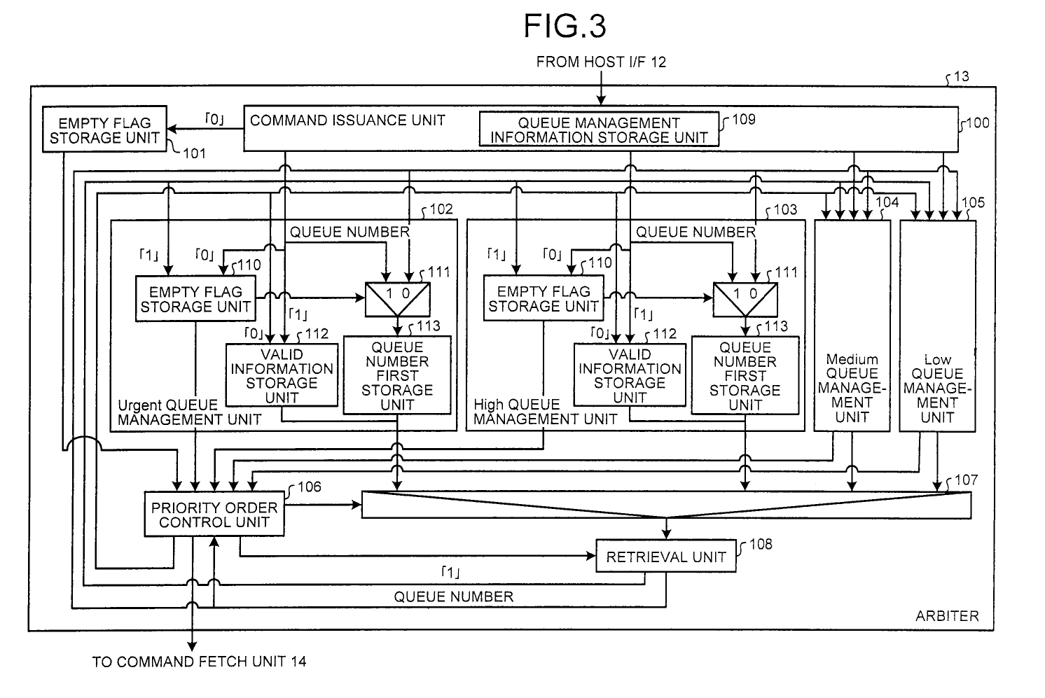

FIG. 3 is a view illustrating an example of a configuration of the arbiter 13.

The arbiter 13 includes a command issuance unit 100, an empty flag storage unit 101, an Urgent queue management unit 102, a High queue management unit 103, a Medium queue management unit 104, a Low queue management unit 105, a priority order control unit 106, a selector 107, and a retrieval unit 108. The Urgent queue management unit 102, the High queue management unit 103, the Medium queue management unit 104, and the Low queue management unit 105 are collectively referred to as a queue management unit in some cases. Specifically, the arbiter 13 includes the queue management unit for each of the priorities “Urgent”, “High”, “Medium”, and “Low”.

The command issuance unit 100 includes a queue management information storage unit 109. The queue management information storage unit 109 stores queue management information having the priority recorded for each queue 22. When the queue number and the number of the commands are inputted from the host I/F 12, the command issuance unit 100 can specify the priority set to the queue 22 to which the command is issued, by referring to the queue management information.

When the command is issued to any one of the Urgent queue 22, the High queue 22, the Medium queue 22, and the Low queue 22, the command issuance unit 100 inputs a reset signal of an empty flag, valid information involved with the queue 22 to which the command is issued, and the queue number of the queue 22 to which the command is issued, to the corresponding queue management unit. When the command is issued to the Admin queue 22, the command issuance unit 100 causes the empty flag storage unit 101 to reset the empty flag value to “0”. The empty flag and the valid information will be described later.

The queue management unit holds information for enhancing efficiency of the retrieval by the arbiter 13. The Urgent queue management unit 102, the High queue management unit 103, the Medium queue management unit 104, and the Low queue management unit 105 have the same configuration, although the target priority is different. The configuration of the Urgent queue management unit 102 will be described here, and the description of the queue management units for the other priorities will be omitted.

The Urgent queue management unit 102 includes an empty flag storage unit 110, a selector 111, a valid information storage unit 112, and a queue number first storage unit 113. The empty flag storage unit 110, the valid information storage unit 112, and the queue number first storage unit 113 are composed of a register (Flip Flop) or a small-scale memory, for example. When information is written in the state in which the empty flag storage unit 110, the valid information storage unit 112, and the queue number first storage unit 113 already have information stored therein, the information that is already stored is overwritten (updated).

The empty flag storage unit 110 stores the empty flag. The empty flag is 1-bit information indicating whether or not the Urgent queue is in an empty state where the command is issued to none of the Urgent queues 22. Upon the change to the empty state, “1” is set to the empty flag, and when the command is issued to any one of the Urgent queues 22, “0” is set to the empty flag.

The valid information storage unit 112 stores the valid information. The valid information is set as 1 bit for each queue 22, and this is information indicating whether the command is issued or not. When the command is issued to the queue 22, “1” is set to the valid information, and when all commands are fetched from the queue 22, “0” is set to the valid information. The valid information is stored in the valid information storage unit 112 for at least all Urgent queues 22. The storage position of the valid information for each queue 22 is determined according to the queue number. The storage position of each valid information is determined in order that the corresponding queue number is set in ascending order.

The queue number first storage unit 113 stores the queue number. The queue number stored in the queue number first storage unit 113 is used as information indicating the retrieval position of the plural queues 22 upon the start of the retrieval. Specifically, the arbiter 13 manages the retrieval position for the plural queues 22.

The selector 111 includes two input terminals to which the queue number is inputted. One of the input terminals is connected to the command issuance unit 100, while the other one is connected to the retrieval unit 108. When the empty flag assumes “1”, the selector 111 selects the input from the command issuance unit 100, and when the empty flag assumes “0”, it selects the input from the retrieval unit 108. The queue number inputted to the input terminal currently selected by the selector 111 is stored in the queue number first storage unit 113.

The empty flag storage unit 101 stores the empty flag indicating the status of the Admin queue 22. Only one Admin queue 22 is provided in the present embodiment. Therefore, the empty flag stored in the empty flag storage unit 101 indicates whether there is a command that is instructed to be fetched in the Admin queue 22 or not.

The priority order control unit 106 can recognize whether the command is issued or not for each priority by confirming the value of the empty flag. When the command is issued to any one of the Urgent queue 22, the High queue 22, the Medium queue 22, and the Low queue 22, the priority order control unit 106 designates the priority of the retrieval range, as well as causes the retrieval unit 108 to retrieve the queue 22 to which the command is issued, and to specify this queue 22. To designate the priority of the retrieval range means that a selection signal for designating a single queue management unit involved with the priority of the retrieval range is inputted to the selector 107. In other words, the priority order control unit 106 sets, one by one, the group for each priority as the target to be retrieved. The priority order control unit 106 generates the fetch instruction in which the command issued to the specified queue 22 is the target to be fetched, and inputs the fetch instruction to the command fetch unit 14.

The retrieval unit 108 carries out the retrieval according to the round robin method within the retrieval range having the priority, out of the priority “Urgent”, the priority “High”, the priority “Medium”, and the priority “Low”, designated by the priority order control unit 106. Specifically, the retrieval unit 108 acquires the valid information and the queue number from the queue management unit designated by the priority order control unit 106 via the selector 107. The retrieval unit 108 retrieves the valid information indicating the value “1” out of the acquired valid information according to the round robin method. The retrieval unit 108 starts the retrieval by using the valid information involved with the queue 22 indicated by the acquired queue number as the retrieval position upon the start of the retrieval. When the retrieval unit 108 finds the valid information with the value “1”, it inputs the queue number for the found valid information into the priority order control unit 106 and the queue management unit. When the retrieval unit 108 does not find the valid information with the value “1” after one round of the retrieval process is ended, it sets the value of the empty flag held in the designated queue management unit to “1”.

Subsequently, the operation of the memory system according to the first embodiment will be described.

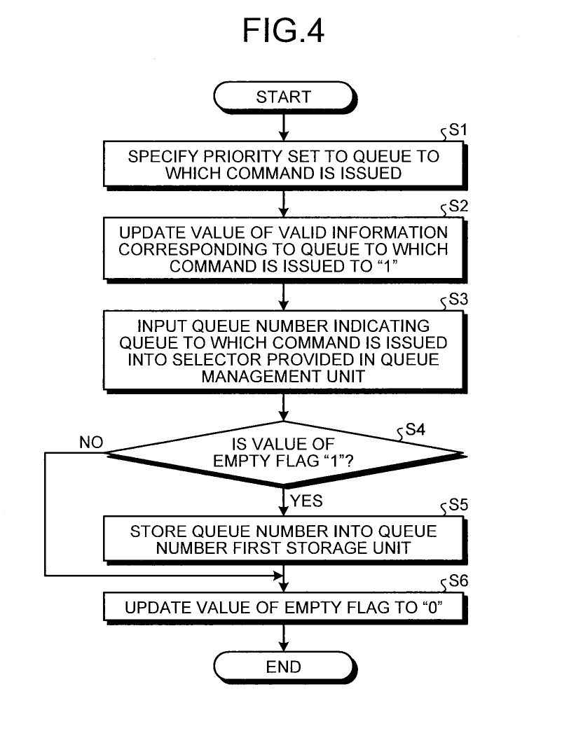

FIG. 4 is a flowchart for describing the operation of the memory system 1 during the issuance of the command.

As described above, when issuing the command to the queue 22, the host 2 notifies the memory system 1 of the queue number indicating the queue 22 to which the command is issued and the number of the stored commands. The command issuance unit 100 specifies the priority set to the queue 22 to which the command is issued by referring to the notification and the queue management information (S1). The command issuance unit 100 updates the value of the valid information, corresponding to the queue 22 to which the command is issued, to “1” (S2). The valid information that is to be updated is the valid information held in the queue management unit for the priority specified by the process in step S1. The succeeding process is executed for the components provided to the queue management unit for the priority specified by the process in step S1, or executed in the queue management unit for the priority specified by the process in step S1.

The command issuance unit 100 inputs the notified queue number to the selector 111 (S3). When the value of the empty flag stored in the empty flag storage unit 110 is “1” (S4, Yes), the queue number inputted to the selector 111 from the command issuance unit 100 is stored in the queue number first storage unit 113 (S5). When the value of the empty flag stored in the empty flag storage unit 110 is “0” (S4, No), the queue number inputted to the selector 111 from the command issuance unit 100 is not selected by the selector 111, so that this queue number is not stored in the queue number first storage unit 113.

Then, the command issuance unit 100 updates the value of the empty flag stored in the empty flag storage unit 110 to “0” (S6), whereby the operation upon the command issuance is ended. When the value of the empty flag is “0” before the process in step S6, the value is not updated by the process in step S6. Alternatively, the value may be updated as “0” again.

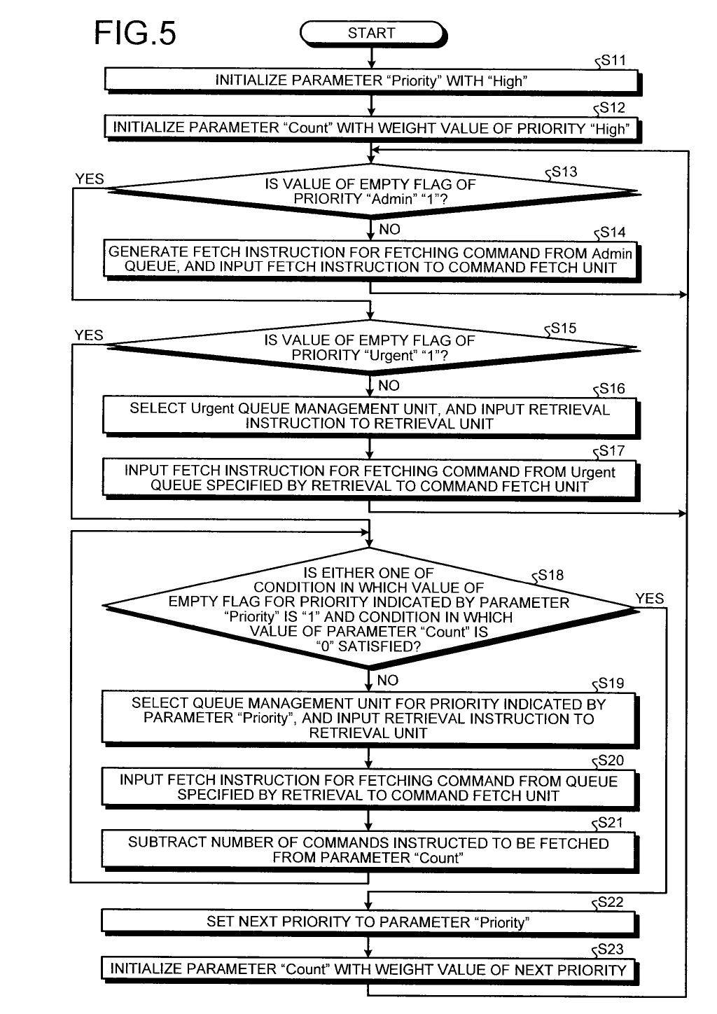

FIG. 5 is a flowchart for describing the operation of the priority order control unit 106. The priority order control unit 106 is supposed to hold a parameter “Priority” and a parameter “Count” therein. The parameter “Priority” and the parameter “Count” are stored in a register (Flip Flop) or in a small-scale memory, for example.

Just after the start, the priority order control unit 106 initializes the parameter “Priority” with the value “High” (S11), and initializes the parameter “Count” with the weight value of the priority “High” (S12).

The priority order control unit 106 then determines whether the value of the empty flag of the priority “Admin” is “1” or not (S13). When the value of the empty flag of the priority “Admin” is “0” (S13, No), the priority order control unit 106 generates the fetch instruction to fetch the command from the Admin queue 22, and inputs the fetch instruction to the command fetch unit 14 (S14). After the process in step S14, the priority order control unit 106 executes again the determination process in step S13.

The priority order control unit 106 is supposed to be capable of acquiring the queue management information and the content notified from the host 2 and inputted to the command issuance unit 100. When plural commands are issued to the Admin queue 22, the priority order control unit 106 can generate the fetch instruction to fetch the plural commands issued to the Admin queue 22.

When the value of the empty flag of the priority “Admin” is “1” (S13, Yes), the priority order control unit 106 determines whether the value of the empty flag of the priority “Urgent” is “1” or not (S15). When the value of the empty flag of the priority “Urgent” is “0” (S15, No), the priority order control unit 106 selects the Urgent queue management unit 102, and inputs the retrieval instruction to the retrieval unit 108 (S16). To select the Urgent queue management unit 102 means that a selection signal for selecting the Urgent queue management unit 102 is inputted to the selector 107.

When receiving the retrieval instruction, the retrieval unit 108 starts the retrieval process. The retrieval unit 108 selects one Urgent queue 22 retrieved by the retrieval process, and inputs the queue number indicating the selected Urgent queue 22 to the priority order control unit 106. The retrieval process by the retrieval unit 108 will be described in detail later.

After the retrieval process, the priority order control unit 106 generates the fetch instruction to fetch the command from the queue 22, which is indicated by the queue number inputted from the retrieval unit 108, out of the Urgent queues 22, and inputs the fetch instruction to the command fetch unit 14 (S17). When finishing the fetch instruction for all commands issued to the queue 22 indicated by the queue number inputted from the retrieval unit 108 by the process in step S17, the priority order control unit 106 updates the corresponding bit in the valid information storage unit 112 to “0”. After the process of step S17, the priority order control unit 106 executes again the determination process in step S13.

When the value of the empty flag of the priority “Urgent” is “1” (S15, Yes), the priority order control unit 106 executes the processes in steps S18 to S21 described next for the priority indicated by the parameter “Priority”. The priority indicated by the parameter “Priority” is described as the priority to be retrieved below.

In the process in step S18, the priority order control unit 106 determines whether either one of the condition in which the value of the empty flag of the priority to be retrieved is “1”, and the condition in which the value of the parameter “Count” is “0” is satisfied or not (S18). When satisfying neither conditions in S18 (S18, No), the priority order control unit 106 selects the queue management unit 102 for the priority to be retrieved, and inputs the retrieval instruction to the retrieval unit 108 (S19). When receiving the queue number from the retrieval unit 108, the priority control unit 106 generates the fetch instruction to fetch the command from the queue 22, which is indicated by the inputted queue number, and inputs the fetch instruction to the command fetch unit 14 (S20). When finishing the fetch instruction for all commands issued to the queue 22 indicated by the queue number inputted from the retrieval unit 108 by the process in step S20, the priority order control unit 106 updates the corresponding bit in the valid information storage unit 112 to “0”. After the process in step S20, the priority order control unit 106 subtracts the number of the inputted commands from the parameter “Count” (S21), and executes again the determination process in step S18.

When at least either one of the conditions in S18 is satisfied (S18, Yes), the priority order control unit 106 sets the next priority out of the priority “High”, the priority “Medium”, and the priority “Low” to the parameter “Priority” (S22), initializes the parameter “Count” by using the weight value of the next priority (S23), and then, executes again the determination process in step S13. In step S22, the priority out of the priority “High”, the priority “Medium”, and the priority “Low” is selected in the order according to the round robin method, every time the process in step S22 is executed, and the selected priority is set.

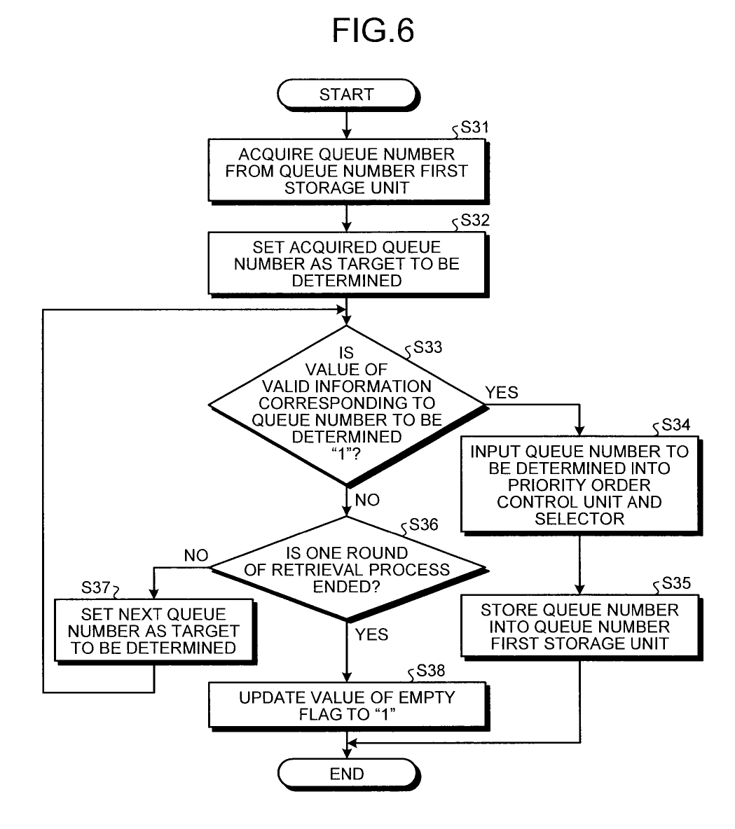

FIG. 6 is a flowchart for describing the retrieval process according to the first embodiment. The retrieval process is executed by using the queue management unit selected by the priority order control unit 106 as a target. In other words, the retrieval process is executed by using the priority indicated by the value of the parameter “Priority” as the target.

When receiving the retrieval instruction, the retrieval unit 108 acquires the queue number from the queue number first storage unit 113 (S31). The retrieval unit 108 sets the acquired queue number as the target to be determined (S32), and determines whether the value of the valid information corresponding to the queue number to be determined, out of the valid information for each queue 22 stored in the valid information storage unit 112 is “1” or not (S33). Two or more queue numbers are not simultaneously set as the target to be determined. When the value of the valid information is “1” (S33, Yes), the retrieval unit 108 inputs the queue number that is set as the target to be determined to the priority order control unit 106 and the selector 111 (S34). Since the value “0” of the empty flag is inputted to the selection signal inputted to the selector 111, the queue number inputted to the selector 111 is stored in the queue number first storage unit 113 (S35). Thus, the retrieval process is ended.

When the value of the valid information is “0” (S33, No), the retrieval unit 108 determines whether one round of the retrieval process is ended or not after the input of the retrieval instruction (S36). To finish one round of the retrieval process means that each of all valid information of the priority to be retrieved is once set as the target to be determined. When one round of the retrieval process is not ended (S36, No), the retrieval unit 108 sets the next queue number as the target to be determined (S37), and executes again the determination process in S33. In step S37, the queue number is selected in the order according to the round robin method, every time the process in step S37 is executed, and the selected queue number is set as the target to be determined. When one round of the retrieval process is ended (S36, Yes), the retrieval unit 108 updates the value of the empty flag to “1” (S38), whereby the retrieval process is ended.

As described above, when the queue 22 to which the command is issued is not found by the retrieval, the value of the empty flag is updated to “1”, and when the command is issued, the value is updated to “0”. When a new command is issued in the state in which the value of the empty flag is “1” (i.e., in the state in which the queue 22 to which the command is issued is not present), the queue 22 to which the new command is issued is stored in the queue number first storage unit 113. Specifically, the arbiter 13 manages the retrieval position, and when a new command is issued in the empty state, it has the retrieval position jump to the queue 22 to which the new command is issued. Thus, the arbiter 13 can carry out the retrieval from the queue 22 to which the new command is issued upon the start of the retrieval process. Therefore, the arbiter 13 can quickly specify the queue 22 to which the new command is issued.

The plural queues 22 are grouped for each priority, and the priority to be retrieved is changed by the priority order control unit 106. The arbiter 13 executes the jump of the retrieval position as described above. Therefore, the arbiter 13 can quickly specify the queue 22 to which the new command is issued, when the retrieval process for the priority, for which the retrieval process is already ended, is again started.

The priority “Urgent” is set to some of the plural queues 22. The priority order control unit 106 changes the priority to be retrieved in accordance with the Weighted Round Robin with Urgent Priority Class Arbitration method. The arbiter 13 also executes the jump of the retrieval position for the Urgent queue 22. Therefore, when a new command is issued to the Urgent queue 22, the arbiter 13 can quickly specify the new command issued to the Urgent queue 22, and execute the command. Thereafter, the arbiter 13 can execute the command issued to the priority “High” to the priority “Low”.

### Second Embodiment

According to a second embodiment, the jump of the retrieval position is controlled in order that the algorithm of the retrieval does not deviate from the round robin method.

Only the queue management unit in the memory system according to the second embodiment is different from the first embodiment. As for the configuration, only the queue management unit will be described, and the redundant description will not be repeated.

As in the first embodiment, the memory system 1 according to the second embodiment includes the queue management units for each of the priority “Urgent”, the priority “High”, the priority “Medium”, and the priority “Low”. Four queue management units provided to the memory system 1 according to the second embodiment have the same configuration, although the target priority is different from one another.

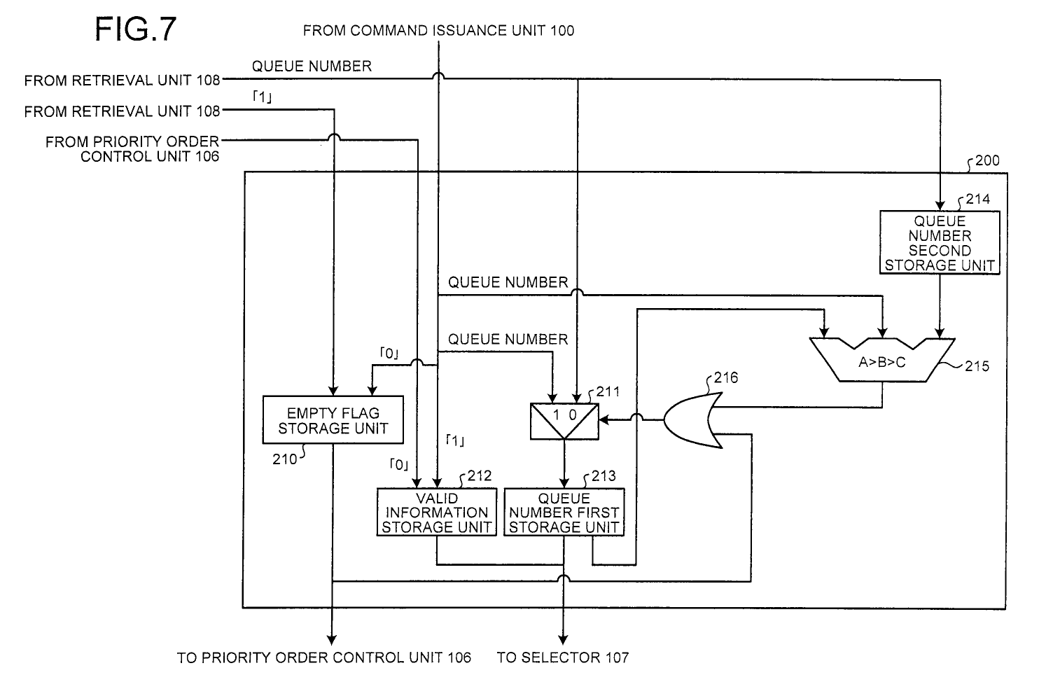

FIG. 7 is a view illustrating an example of a configuration of the queue management unit according to the second embodiment.

The queue management unit 200 includes an empty flag storage unit 210, a selector 211, a valid information storage unit 212, a queue number first storage unit 213, a queue number second storage unit 214, a comparator 215, and an OR circuit 216.

The empty flag storage unit 210 stores an empty flag. The valid information storage unit 212 stores the valid information.

The queue number first storage unit 213 stores the queue number inputted from the command issuance unit 100 or the retrieval unit 108. The queue number second storage unit 214 stores the queue number inputted from the retrieval unit 108.

The selector 211 includes two input terminals to which the queue number is inputted. One of the input terminals is connected to the command issuance unit 100, while the other one is connected to the retrieval unit 108. When the value of the selection signal is “1”, the selector 211 selects the input from the command issuance unit 100, and when the value of the selection signal is “0”, it selects the input from the retrieval unit 108.

The comparator 215 accepts inputs of the queue number (A) stored in the queue number first storage unit 213, the queue number (B) inputted from the command issuance unit 100 upon the command issuance, and the queue number (C) stored in the queue number second storage unit 214. When the relationship of A>B>C is established, the comparator 215 inputs the value “1” to the OR circuit 216. When the relationship of A>B>C is not established, it inputs the value “0” to the OR circuit 216.

The OR circuit 216 executes OR operation of the value inputted from the comparator 215 and the value of the empty flag. The OR circuit 216 inputs the result of the OR operation to the selector 211 as the selection signal of the selector 211.

In this embodiment, it is supposed that the queue number is retrieved in the ascending order. Accordingly, the comparator 215 and the selector 211 can select the queue number indicating the queue 22, which is retrieved earlier, out of the queue 22 indicated by the queue number stored in the queue number first storage unit 213 and the queue 22 to which a new command is issued, in cooperation with each other, when the retrieval process is carried out from the queue that is selected by the last retrieval process.

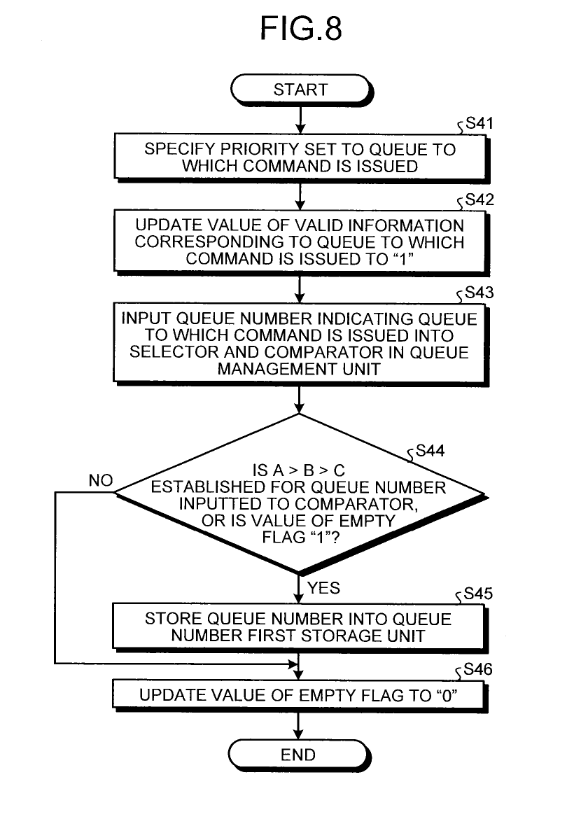

FIG. 8 is a flowchart for describing the operation of the memory system 1 during the issuance of the command according to the second embodiment.

The command issuance unit 100 executes the processes same as the processes in steps S1 and S2 in steps S41 and S42. The process after the process in step S42 is executed for the components provided to the queue management unit for the priority specified by the process in step S41, or executed in the queue management unit for the priority specified by the process in step S41.

After the process in step S42, the command issuance unit 100 inputs the queue number notified from the host 2 to the selector 211 and the comparator 215 (S43). When at least one of the condition in which the relationship of A>B>C is established among the queue number (A) stored in the queue number first storage unit 213, the queue number (B) inputted to the comparator 215 by the process in step S43, and the queue number (C) stored in the queue number second storage unit 214, and the condition in which the value of the empty flag stored in the empty flag storage unit 210 is “1” is satisfied (S44, Yes), the queue number inputted to the selector 211 from the command issuance unit 100 is stored in the queue number first storage unit 213 (S45). When neither condition is satisfied in step S44 (S44, No), the queue number inputted to the selector 211 from the command issuance unit 100 is not selected by the selector 211, so that this queue number is not stored in the queue number first storage unit 213.

Then, the command issuance unit 100 updates the value of the empty flag stored in the empty flag storage unit 210 to “0” (S46), whereby the operation upon the command issuance is ended.

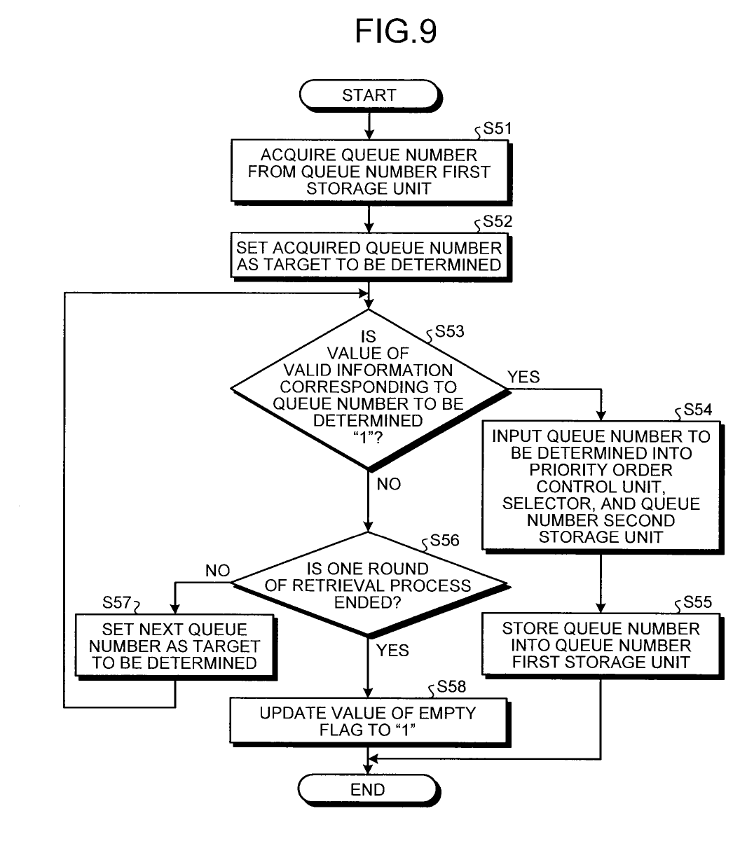

FIG. 9 is a flowchart for describing the retrieval process according to the second embodiment. As in the first embodiment, the retrieval process is executed by using the queue management unit selected by the priority order control unit 106 as a target. In other words, the retrieval process is executed by using the priority indicated by the value of the parameter “Priority” as the target.

The retrieval unit 108 executes the processes same as the processes in steps S31 and S32 in steps S51 and S52. The retrieval unit 108 determines whether the value of the valid information corresponding to the queue number to be determined, out of the valid information, for each queue 22, stored in the valid information storage unit 212 is “1” or not (S53). When the value of the valid information is “1” (S53, Yes), the retrieval unit 108 inputs the queue number that is set as the target to be determined to the priority order control unit 106, the selector 211, and the queue number second storage unit 214 (S54). The following processes in steps S55 to S58 are the same as the processes in steps S35 to S38.

As described above, the queue number selected by the last retrieval process is stored in the queue number second storage unit 214. In cooperation with each other, the comparator 215 and the selector 211 select the queue number indicating the queue 22, which is retrieved earlier, out of the queue 22 indicated by the queue number stored in the queue number first storage unit 213 and the queue 22 to which a new command is issued, when the retrieval process is carried out from the queue that is selected by the last retrieval process. With this process, when a new command is issued to two or more queues 22 on a different timing during the period from the change to the empty state till the start of the retrieval process, the arbiter 13 can have the retrieval position jump to the queue 22 that is retrieved the earliest, out of the two or more queues 22 to which the new command is issued, in the case where the retrieval process is started from the queue 22 selected by the last retrieval process. Consequently, according to the second embodiment, the arbiter 13 can quickly specify the queue 22 to which the new command is issued without preventing the retrieval algorithm from being deviated from the round robin method.

The arbiter 13 stores the queue 22 on the jumped retrieval position in the queue number first storage unit 213, and when a new command is issued, the arbiter 13 has or does not have the retrieval position jump to the queue 22 to which the new command is issued. The configuration of the arbiter 13 is not limited to the above configuration, so long as the arbiter 13 can always have the retrieval position jump to the queue 22 that is retrieved the earliest when the retrieval process is started from the queue 22 selected by the last retrieval process. For example, when a new command is issued to the queue 22 during the period from the change to the empty state till the start of the retrieval process, the arbiter 13 may be configured to store all queue numbers indicating the queue 22 to which the new command is issued.

All of or some of the components in each embodiment can be realized by hardware, software, or a combination of them. To realize by software means that, in a computer including an operation device and a storage device, a program module corresponding to each component is stored in the storage unit, and the program module stored in the storage unit is executed by the operation device, in order to realize the function of each component. All of or some of the components in each embodiment can be realized by ASIC. Whether each component is realized by hardware or software depends upon a specific embodiment or a design limitation imposed on the entire system. A person skilled in the art can realize these functions by various forms for each of the specific embodiments, and to decide such realization is included in the scope of the present invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A controller comprising:
an arbiter that executes a retrieval process of selecting a queue to which a command is issued out of a plurality of queues by a retrieval according to a round robin method;
a command fetch unit that fetches a command from the selected queue; and
a processing unit that executes a process according to the fetched command to a memory chip, wherein
the arbiter manages a retrieval position, and when a new command is issued to any one of the plurality of queues in an empty state in which there is no queue to which a command is issued, the arbiter has the retrieval position jump to the queue to which the new command is issued.

2. The controller according to claim 1, wherein
the plurality of queues are grouped into a plurality of groups for each priority, and
the arbiter manages the retrieval position for each group, sets each of the plurality of groups, one by one, as a target to be retrieved according to the round robin method, and executes the retrieval process within a range of the queues belonging to the group that is the target to be retrieved.

3. The controller according to claim 2, wherein
at least one of the plurality of groups has a priority “Urgent” set thereto, and
the arbiter executes the retrieval process in accordance with a Weighted Round Robin with Urgent Priority Class Arbitration method.

4. The controller according to claim 1, wherein
when a new command is issued to two or more queues on a different timing during a period from a change to the empty state till a start of the retrieval process, the arbiter has the retrieval position jump to the queue that is retrieved the earliest out of the two or more queues to which the new command is issued in case where the retrieval process is started from the queue selected by the last retrieval process.

5. The controller according to claim 4, wherein
the plurality of queues are grouped into the plurality of groups for each priority, and
the arbiter manages the retrieval position for each group, sets each of the plurality of groups, one by one, as a target to be retrieved according to the round robin method, and executes the retrieval process within a range of the queues belonging to the group that is the target to be retrieved.

6. The controller according to claim 5, wherein
at least one of the plurality of groups has a priority “Urgent” set thereto, and
the arbiter executes the retrieval process in accordance with a Weighted Round Robin with Urgent Priority Class Arbitration method.

7. A memory system comprising:
a memory chip;
an arbiter that executes a retrieval process of selecting a queue to which a command is issued out of a plurality of queues by a retrieval according to a round robin method;
a command fetch unit that fetches a command from the selected queue; and
a processing unit that executes a process according to the fetched command to a memory chip, wherein
the arbiter manages a retrieval position, and when a new command is issued to any one of the plurality of queues in an empty state in which there is no queue to which a command is issued, the arbiter has the retrieval position jump to the queue to which the new command is issued.

8. The memory system according to claim 7, wherein
the plurality of queues are grouped into the plurality of groups for each priority, and
the arbiter manages the retrieval position for each group, sets each of the plurality of groups, one by one, as a target to be retrieved according to the round robin method, and executes the retrieval process within a range of the queues belonging to the group that is the target to be retrieved.

9. The memory system according to claim 8, wherein
at least one of the plurality of groups has a priority “Urgent” set thereto, and
the arbiter executes the retrieval process in accordance with a Weighted Round Robin with Urgent Priority Class Arbitration method.

10. The memory system according to claim 7, wherein
when a new command is issued to two or more queues on a different timing during a period from a change to the empty state till a start of the retrieval process, the arbiter has the retrieval position jump to the queue that is retrieved the earliest out of the two or more queues to which the new command is issued in case where the retrieval process is started from the queue selected by the last retrieval process.

11. The memory system according to claim 10, wherein
the plurality of queues are grouped into the plurality of groups for each priority, and
the arbiter manages the retrieval position for each group, sets each of the plurality of groups, one by one, as a target to be retrieved according to the round robin method, and executes the retrieval process within a range of the queues belonging to the group that is the target to be retrieved.

12. The memory system according to claim 11, wherein
at least one of the plurality of groups has a priority “Urgent” set thereto, and
the arbiter executes the retrieval process in accordance with a Weighted Round Robin with Urgent Priority Class Arbitration method.

13. The memory system according to claim 7, wherein
the plurality of queues are provided to the host, and a command is issued by the host.

14. The memory system according to claim 8, wherein
the arbiter is notified of the queue to which the command is issued from the host, every time the command is issued by the host.

15. A method of controlling a memory chip by a controller, the method comprising:
executing a retrieval process of selecting a queue, to which a command is issued, out of a plurality of queues by a retrieval according to a round robin method;
fetching the command from the selected queue;
executing a process according to the fetched command to the memory chip;
storing a retrieval position of the retrieval process; and
when a new command is issued to any one of the plurality of queues in an empty state in which there is no queue to which a command is issued, having the retrieval position jump to the queue to which the new command is issued.

16. The method according to claim 15, further comprising:
grouping the plurality of queues into the plurality of groups for each priority;
storing the retrieval position for each group;
setting each of the plurality of groups one by one as a target to be retrieved according to the round robin method; and
executing the retrieval process within a range of the queues belonging to the group that is the target to be retrieved.

17. The method according to claim 16, further comprising:
setting a priority “Urgent” to at least one of the plurality of groups; and
executing the retrieval process in accordance with a Weighted Round Robin with Urgent Priority Class Arbitration method.

18. The method according to claim 15, further comprising:
when a new command is issued to two or more queues on a different timing during a period from a change to the empty state till a start of the retrieval process, having the retrieval position jump to the queue that is retrieved the earliest out of the two or more queues to which the new command is issued in case where the retrieval process is started from the queue selected by the last retrieval process.

19. The method according to claim 18, further comprising:
grouping the plurality of queues into the plurality of groups for each priority;
storing the retrieval position for each group;
setting each of the plurality of groups one by one as a target to be retrieved according to the round robin method; and
executing the retrieval process within a range of the queues belonging to the group that is the target to be retrieved.

20. The method according to claim 19, further comprising:
setting a priority “Urgent” to at least one of the plurality of groups; and
executing the retrieval process in accordance with a Weighted Round Robin with Urgent Priority Class Arbitration method.
